(19) United States
(12) Patent Application Publication
(10) Pub. No.: US 2016/0149538 A1
(43) Pub. Date: May 26, 2016

(54) Mobile device for converting solar energy to electricity

(71) Applicant: GO2NET POLAND SP. Z.O.O., Leszno (PL)

(72) Inventors: Jacek PRYPIN, Swidnica (PL); Ewelina KORCZAK, Bielany Wroclawskie (PL)

(73) Assignee: GO2NET POLAND SP. Z O.O., Leszno (PL)

(21) Appl. No.: 14/655,930

(22) PCT Filed: Oct. 30, 2014
(86) PCT No.: PCT/PL2014/000119

§ 371 Date: Jun. 26, 2015

(51) Int. Cl. H02S 30/20; H02S 10/40

(52) U.S. Cl. CPC H02S 30/20; H02S 10/40

(57) ABSTRACT

A mobile device for converting solar energy into electricity in a portable or transportable version consisting of interconnected photovoltaic cells module (1) and energy storage module (2) characterised in that the photovoltaic cell module (1) consists of a set of flexible photovoltaic panels with a certain power output together with a set of cables to connect the panels to the energy storage module, whereas the cells are placed on a foldable frame and the energy storage module (2) comprises a set of batteries placed in a portable housing with a size typical of the size of a laptop and is equipped with an electronic circuit with a display, which is used to carry out and check the charging and discharging processes, whereas before the above elements are assembled, the set of flexible photovoltaic panels together with the set of cables to connect the panels to the energy storage module is located in the first tube case, whereas the foldable frame, together with accessories for the deployment and fixing of the set of photovoltaic panels on the frame and/or in another accessible location and/or on a vehicle, is located in the second tube case.

The object of the invention is a mobile (portable or transportable) device for converting solar energy into electricity to be used in real time or to be stored for later use in order to power electrical equipment.

The prior art discloses a variety of devices for converting solar energy into electricity. For example, the devices known from the prior art are dedicated to specific applications, i.e. devices to be used in mobile low-power LED lamps (used eg. in gardens) or to power street lamps. The prior art also discloses devices for converting solar energy into electricity that are integrated into a vehicle and that operate only in connection with the vehicle (for example, photovoltaic systems mounted on trailers, caravans, boats). Finally, the prior art discloses stationary photovoltaic installations.

Neither of the solutions known in the prior art takes advantage of the capabilities of flexible photovoltaic cells, which can be deployed using a portable mounting system and any available attachment points (standalone on the ground or using vehicles, poles, buildings, etc). There are also no solutions that would involve fully mobile and versatile devices for converting solar energy into electricity.

A mobile device for converting solar energy into electricity consisting of interconnected photovoltaic cells module (1) and energy storage module (2) according to the invention is characterised in that that photovoltaic cell module (1) comprises a set of flexible photovoltaic panels with a certain power output together with a set of cables to connect the panels to the energy storage module, whereas the cells are placed on a foldable frame and the energy storage module (2) comprises a set of batteries placed in a portable housing with a size typical of the size of a laptop and is equipped with an electronic system with a display, which is used to power electrical equipment and to carry out charging and discharging and checks its status, whereas before the above elements are assembled, the set of flexible photovoltaic panels together with the set of cables to connect the panels to the energy storage module is located in the first tube case, whereas the foldable frame together with accessories for the deployment and fixing of the set of photovoltaic panels on the frame and/or in another accessible location and/or on a vehicle is located in the second tube case.

Preferably, the portable housing has the size of a suitcase and the powered devices are compatible with 5V DC USB ports, 12V DC car lighter sockets and 110 or 230V AC power outlets.

The energy storage module also has a recharging (energy replenishment) feature via a 110 or 230V 50 mains.

The device according to the invention has been presented below in embodiments. The embodiments describe the device depending on the version. The version of the device (either portable or transportable) is determined on the basis of the dimensions and the weight of the components in such a manner that a single person is able to carry the portable version around whereas the transportable version can be carried by at least two people or by a vehicle.

The object of the invention is illustrated in the embodiments in the drawing, in which

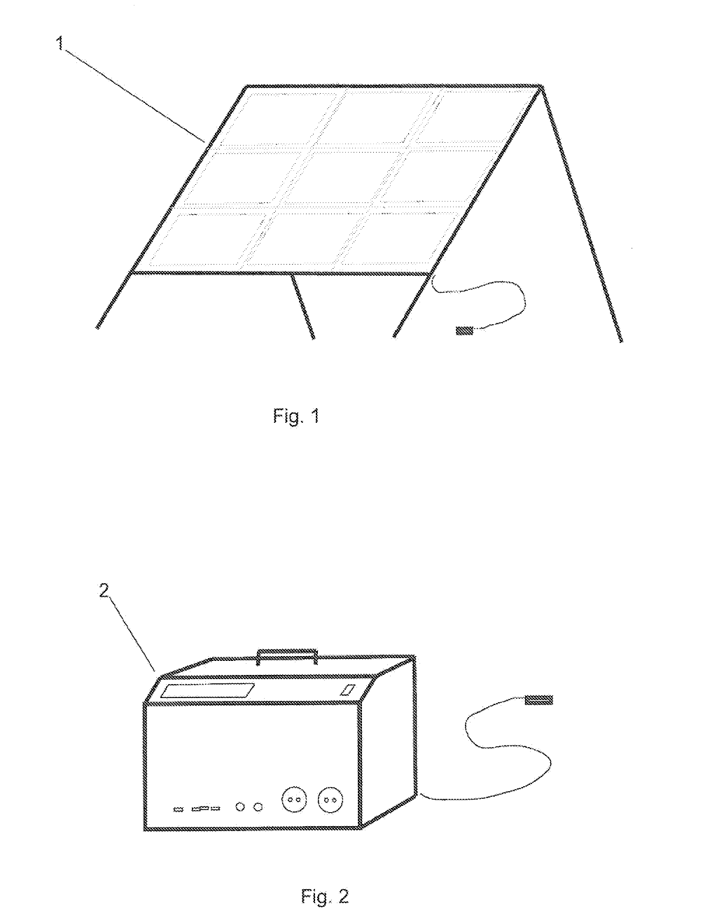

FIG. 1 shows photovoltaic cells module (1) and

FIG. 2—energy storage module (2).

### EMBODIMENT 1

The embodiment of a portable device.

A mobile device for converting solar energy into electricity consisting of interconnected photovoltaic cells module (1) and energy storage module (2). The photovoltaic cells module (1) consists of a set of flexible photovoltaic panels with a certain power output of about 200 Wp together with a set of cables to connect the panels to the energy storage module, whereas the cells are placed on a frame.

Before the above elements are assembled, the set of flexible photovoltaic panels together with a set of cables to connect the panels to the energy storage module (2) is located in the first tube case, whereas the foldable frame together with accessories for the deployment and fixing of the set of photovoltaic panels on the frame and/or in another accessible location and/or on a vehicle is located in the second tube case. The mounting accessories allow the user to deploy and fix the set of photovoltaic panels on the frame, on the ground or onto any other available mounting location such as a car, pole, building, etc.

The energy storage module (2) consists of a set of batteries placed in a portable housing with a size typical of the size of a laptop. In addition, the module (2) is equipped with an electronic circuit with a display. The circuit is used to power electrical equipment and to carry out and check the status of charging and discharging.

The energy storage module (2) consists of batteries and is equipped with a charging and discharging control system with the ability to power the receiver. It is also equipped with measuring and safety features (charging and discharging parameters, available energy, the total number of cycles, self-diagnostics). The amount of the photovoltaic panels and the capacity of the batteries depend on the version of the device; the portable version of the device will allow generating and storing up to around 1 kWh of electricity, which can be illustrated as continuous operation of a 100 W laptop over approx. 10 hours.

The device according to the invention in the portable version will allow the user to power devices such as a portable computer and any mobile devices compatible with a USB port, 12V care lighter and 110 or 230V AC power supply within the respective limits of power and energy.

### EMBODIMENT 2

In this embodiment the device according to the invention is a transportable device. The elements that constitute the device are proportionately larger whereas the manner of their fixing, connection and use is the same as in embodiment 1. In this version, under optimal conditions, the set of photovoltaic panels and the energy storage allow the user to generate and store up to 4 kWh electricity which can illustrated as the operation of a 1 kW electric kettle for about 4 hours.

### The Principle of Operation of the Device According to the Invention

1. Collection of Energy (Charging)

To have the charger collect electricity in the energy storage module (2):
1) choose the place of highest insolation for the period of energy collection
2) unfold the frame that is a part of the set and use the frame or other attachment points to unfold and mount the set of photovoltaic panels (1) so that sun rays fall as perpendicularly as possible to the face of the unfolded panels
3) place the energy storage module (2) near the set of panels (1) and connect the module to the set of panels (1) using the cables
4) use the control panel of the energy storage module (2) to check whether the energy collection process has started

The electric energy generated in a set of photovoltaic panels (1) is transmitted to and stored in the energy storage module (2) for later use.

2. Simultaneous Energy Collection (Charging) and Consumption

To have the charger collect electricity in the energy storage module (2):
1) choose the place of highest insolation for the period of energy collection
2) unfold the frame that is a part of the set and use the frame or other attachment points to unfold and mount the set of photovoltaic panels (1) so that sun rays fall as perpendicularly as possible to the face of the unfolded panels
3) place the energy storage module (2) near the set of panels (1) and connect the module to the set of panels (2) using the cables
4) use the control panel of the energy storage module (2) to check whether the energy collection process has started
5) connect the appropriate receivers i.e. a portable computer to the energy storage module (2)

The electric energy generated in a set of photovoltaic panels (1) is transmitted to and stored in the energy storage module (2) and at the at the same time is transmitted to the receivers

3. Use of the Stored Energy (Discharging)

To have the charger provide the electrically previously collected in the energy storage module (2):
1) move the energy storage module (2) to a convenient location to connect the receivers
2) connect the receivers and use the stored energy
3) using the control panel of the energy storage module (2) check the amount of available energy

The electricity collected in the energy storage module (2) is used by the receiver or receivers.

1. A mobile device for converting solar energy into electricity in a portable or transportable version consisting of interconnected photovoltaic cells module (1) and energy storage module (2) characterised in that the photovoltaic cell module (1) consists of a set of flexible photovoltaic panels with a certain power output together with a set of cables to connect the panels to the energy storage module, whereas the cells are placed on a foldable frame and the energy storage module (2) comprises a set of batteries placed in a portable housing with a size typical of the size of a laptop and is equipped with an electronic circuit with a display, which is used to carry out and check the charging and discharging processes, whereas before the above elements are assembled, the set of flexible photovoltaic panels together with the set of cables to connect the panels to the energy storage module is located in the first tube case, whereas the foldable frame, together with accessories for the deployment and fixing of the set of photovoltaic panels on the frame and/or in another accessible location and/or on a vehicle, is located in the second tube case.

2. A mobile device for converting solar energy into electricity in the transportable version according to claim 1 is characterised in that the housing of the energy storage module has the size of a suitcase.

3. The energy storage module according to claim 1 has, for each version, an energy storage (charging) feature using either the photovoltaic module or a 110/230V AC mains.
